(19) United States
(12) Patent Application Publication
(10) Pub. No.: US 2024/0426432 A1
(43) Pub. Date: Dec. 26, 2024

(54) ON-TANK VALVE

(71) Applicant: Metier Ventures Limited, Kirtlington (GB)

(72) Inventors: Robert Lees, Daventry (GB); Kyle Webb, Abingdon (GB)

(73) Assignee: Metier Ventures Limited, Kirtlington (GB)

(21) Appl. No.: 18/746,726

(22) Filed: Jun. 18, 2024

(30) Foreign Application Priority Data
Jun. 22, 2023 (GB) GB2309402.2

(51) Int. Cl. F17C 13/04

(52) U.S. Cl. CPC F17C 13/04; F17C 2205/0326; F17C 2205/0329; F17C 2205/0332; F17C 2205/0335; F17C 2223/0123; F17C 2250/043; F17C 2250/0439

(57) ABSTRACT

An on-tank valve for fitting to a tank to supply stored gas to a consumer and the tank to be replenished with gas from a filling station. The valve has a valve body defining at least two flow passages in communication with the tank. A first flow passage incorporates a solenoid valve to control the flow of gas from the tank to the consumer and the second incorporates a manually operable bleed valve for stored gas to be supplied to the consumer while bypassing the solenoid valve. The bleed valve is a combination valve movable manually between two states. In the first state stored gas is permitted to flow from the tank to the consumer and in the second state the second passage incorporates a non-return valve to permit the tank to be replenished from the filling station without the replenishment gas passing through the solenoid valve.

### FIELD OF THE INVENTION

The present invention relates to an on-tank valve for filling and discharging of storage tanks with a gas or gaseous medium, such as Compressed Natural Gas (CNG) or Compressed Gaseous Hydrogen (CGH or H2). Such tanks may be used for fuel storage on board a vehicle or in fuel production, handling, storage, transportation, and distribution.

### BACKGROUND OF THE INVENTION

FIG. 1 of the accompanying drawings is a schematic diagram of a typical fuel system for a production engine. Fuel for the engine 500 is stored in a fuel storage unit 502 shown as comprising three tanks 504 connected in cascade, each having its own on-tank valve 506. The fuel in the storage unit is replenished from a receptacle 508 that incorporates a filter and a non-return valve in its output, the fuel entering the storage unit 502 through a further non-return valve 510. Fuel from the storage unit 502 is supplied to the engine by way of a dual-stage fixed outlet pressure regulator 512, a shut-off valve 514 and a further filter 516. The output line of the pressure regulator is also connected to a service valve 518. The present invention is concerned in particular with the on-tank valves 506.

The concept of an on-tank valve (OTV) is currently well understood, with several manufacturers producing such a product in volume production. Typically, on-tank valves consist of a solid body that can be screwed into a storage tank, and having machined features that allow the fitment of several primary fluid control and safety devise such as:
(i) a manually operated tank isolation valve (MV),
(ii) a manually operated bleed valve for allowing extraction of tank contents, (BV),
(iii) a solenoid shut off valve (SV) to allow extraction of tank contents for consumption by the vehicle, which in a vehicle is controlled by the vehicle electronic control unit (ECU),
(iv) an excess flow valve (EFV), which is a safety device that limits the flow of fluid from the tank in the event of downstream rupture, such as a burst pipe, accidental damage, etc.
(v) a thermally activated pressure relief device (TPRD) that releases pressure from the storage tank, if in-tank temperature rises beyond a specified limit, e.g. in the event of a fire.

Furthermore, in order to provide feedback of in-tank conditions to the vehicle/filling station control system, on-tank valves are normally also equipped with a temperature and a pressure sensor.

A schematic diagram of a typical known on-tank valve 506 is shown in FIGS. 2A and 2B of the accompanying drawings, with arrows indicating in FIG. 1A the direction of gas flow during filling and in FIG. 1B the direction of gas flow during fuel extraction.

In FIG. 2A, fuel from an inlet 10 flows in the direction represented by arrows 11 through the opened manually operated isolation valve 12 to the solenoid operated valve 14. The latter is a two-port valve having a valve spool with two positions. In the position shown in FIG. 2A, the spool allows flow towards the tank 16 but not in the opposite direction. Prior to reaching the tank 16, the gas flows through an excess flow valve 18 and a filter 20.

In FIG. 2B, the spool of the solenoid valve 14 is moved to its second position in which gas flow is allowed between its two ports in both directions and gas flows in the direction represented by arrows 13 towards the fuel outlet 22, that leads to a consumer such as a vehicle engine.

The two figures also show a pressure sensor 24 and a temperature sensor 26. The lines connected to the sensors 24, 26 and to the solenoid of the valve 14 are shown as broken lines, because, unlike the other lines in the figures, they carry electrical signals, not gas. Also shown in both figures are a manually operated bleed valve 28, which allows gas to be extracted from the tank via the downstream service valve 518, while bypassing the solenoid valve 14 and a thermally activated pressure relief device 30 that vents the tank 16 in the event of its overheating.

Additionally, other control elements such as non-return (check) valves may often be incorporated in the on-tank valve to provide specific functionality or to control the flow path of fluid through the valve depending on the usage scenario, such as filling or emptying of the tank.

During a filling operation, high pressure fluid must pass through the solenoid valve, the excess flow valve and filter. With the arrangement detailed in FIGS. 2A and 2B, several problems arise. In particular, because high pressure fluid are required to pass through the solenoid valve and the excess flow valve, the following apply:
The solenoid valve must act as a check valve;
The solenoid valve and excess flow valve must be capable of high flow rates in the filling direction, approximately 20× higher than when fuel is being consumed;
The solenoid valve must be robust to pressure fluctuations;
Control of valve chatter is required—an issue caused by high flow rates; and
The restriction caused by the solenoid valve, excess flow valve and filter will result in a pressure drop through the tank valve, which must be compensated by increased energy input to the filling station pump.

All these requirements result in increased energy consumption, complexity and cost.

A potential solution would be to add a separate ‘high flow’ fill passage. Such an arrangement, which is shown in FIG. 3, adds a dedicated filling line 40 to the on-tank valve 100 that bypasses the solenoid valve 14 and excess flow valve 18. In this figure, the direction of gas flow during replenishment is represented by darker arrows and that during consumption of the gas by lighter arrows.

Such an arrangement would still have two drawbacks, namely:

1. Concurrent filling of multiple storage tanks, at the required fill rate, is not possible with a single supply line from the filling station. Therefore, a separate dedicated manifold would be required to split the filling line to each tank. The necessary multiple high pressure lines and connections increase cost and susceptibility to leakage.

2. Extra machining is required in the on-tank valve body to provide the dedicated filling passage.

### OBJECT OF THE INVENTION

The invention seeks to provide an on-tank valve that mitigates at least some of the problems experienced with known on-tank valves, without the need to increase the number of flow passages in the valve body fitted to the tank and while permitting multiple tanks to be replenished from a common supply line.

### SUMMARY OF THE INVENTION

According to the present invention, there is provided on-tank valve for fitting to a tank to permit a gas stored in the tank to be supplied to a consumer of the gas and to permit the tank to be replenished with the gas from a filling station, the valve having a valve body defining at least two flow passages in communication with the tank, a first of the two flow passages incorporating a solenoid valve to control the flow of gas from the tank to the consumer and the second incorporating a manually operable bleed valve for enabling stored gas be supplied to the consumer while bypassing the solenoid valve, characterized in that the bleed valve is a combination valve movable manually between two states, wherein in the first state stored gas is permitted to flow from the tank to the consumer and in the second state the second passage incorporates a non-return valve to permit the tank to be replenished from the filling station without the replenishment gas passing through the solenoid valve.

In some embodiments, first passage comprises a manually operable isolation valve connected in series with the solenoid valve and preferably arranged between the solenoid valve and the tank.

The isolation valve may, in some embodiments, be a combination valve movable manually between two states, wherein in the first state the tank is isolated and in the second state the tank is connected to the solenoid valve by way of a non-return valve oriented to be permit stored gas to flow from the tank to the solenoid valve.

### BRIEF DESCRIPTION OF THE DRAWINGS

The invention will now be described further, by way of example, with reference to the accompanying drawings, in which:

FIG. 1 is, as earlier described, a schematic diagram of a typical fuel system for a production engine,

FIGS. 2A and 2B, as previously described, show schematic diagrams of a prior art on-tank valve operating in different modes,

FIG. 3 is a modification of the valve of FIGS. 2A and 2B1, not in accordance with the invention, to permit the solenoid valve to be bypassed during replenishment of the tank,

FIG. 4 is a schematic diagram similar to that of FIGS. 2A and 2B of an on-tank valve of the present invention,

FIGS. 5 and 6 are sections of a combined bleed and check valve in different states of the valve, and

FIGS. 7 and 8 are sections of a combined manual shut-off and check valve in different states of the valve.

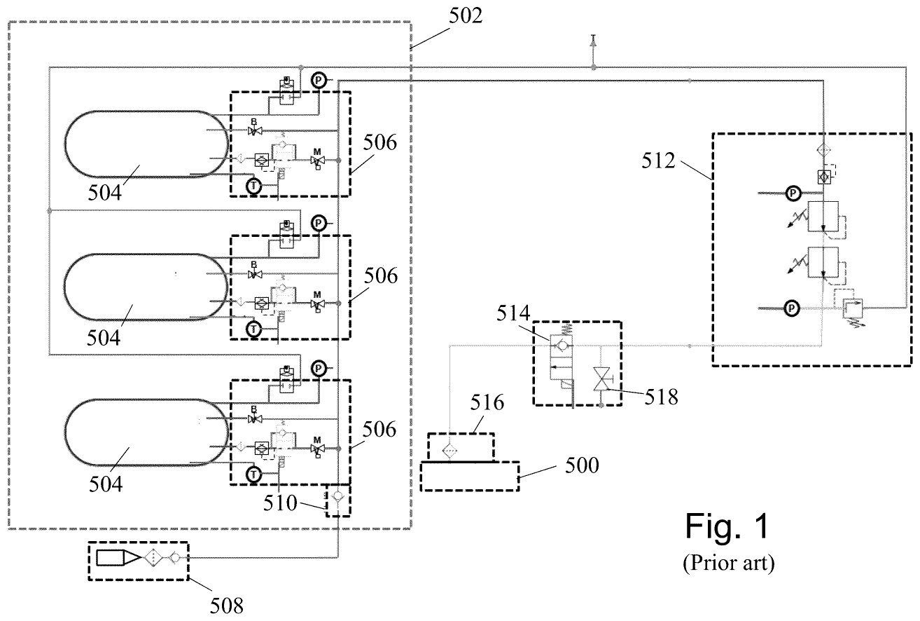

### DETAILED DESCRIPTION OF THE DRAWINGS

To avoid unnecessary repetition, in describing the embodiment of the invention shown in FIG. 4, the components serving the same purpose as in the prior art have been allocated the same reference numerals and will not be described a second time. Components that have been modified but serve an analogous purpose have been allocated reference numerals with the same last two significant digits. Arrows in two different shades have been added to the drawing to indicate the direction of gas flow, the darker arrows indicating the gas flow during replenishment and those in the lighter shade indicating the gas flow to the consumer from the tank.

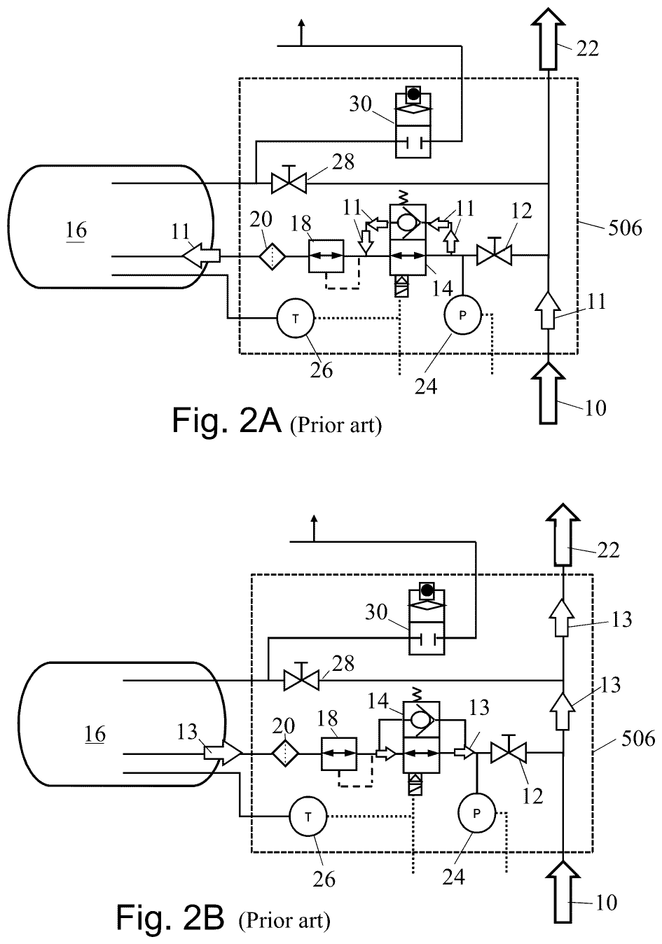

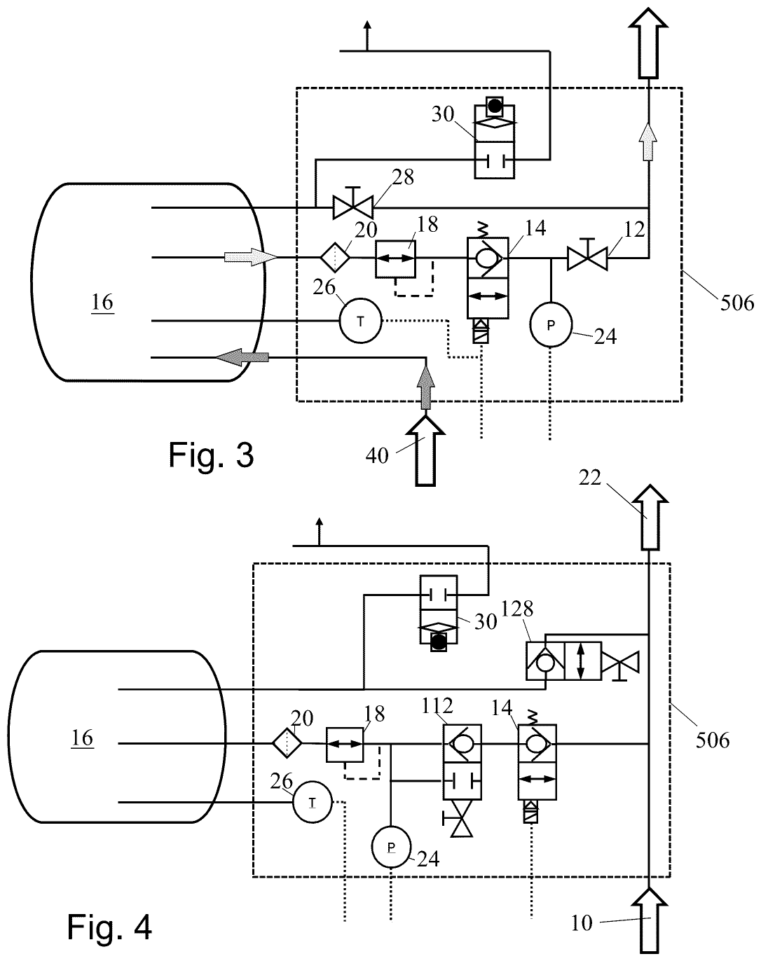

In the invention, the bleed valve 28 of FIGS. 2A and 2B is replaced by a valve 128 which is a combined bleed and check valve. When moved to the bleed valve state, the valve serves the same purpose as in the prior art of allowing the solenoid valve 14 to be bypassed. However, when not serving as a bleed valve, the valve 128, as represented by the darker arrows, serves as a check valve to allow the tank 16 to be filled from the inlet 10 while bypassing the solenoid valve 14.

The embodiment of FIG. 4 also differs from the prior art in that the manual shut-off valve 12 has been moved from one side of the solenoid valve 14 to the other and lies between the solenoid valve 14 and the tank. This allows the solenoid valve 14 to be removed for servicing or inspection even when the tank 16 is full. Furthermore, the manual shut-off valve 12 has been replaced by a combined valve 112 having a second state in which it functions as a non-return valve. As the solenoid valve 14 will allow flow of gas towards the tank 16 in both its positions, the check valve state of the combined manual valve 112 prevents gas from entering the tank when the tank is not fully isolated.

It will be seen from the above description that the embodiment of the invention shown in FIG. 4, can provide a passage for high flow rate tank filling that bypasses the solenoid valve during the filling operation, without the need for additional passages that require additional machining/drilling operations and may possibly also require external seals. The on-tank valve also allows concurrent filling of multiple storage tanks, connected in series, thereby avoiding the need for an external distribution manifold and additional high pressure lines/fittings.

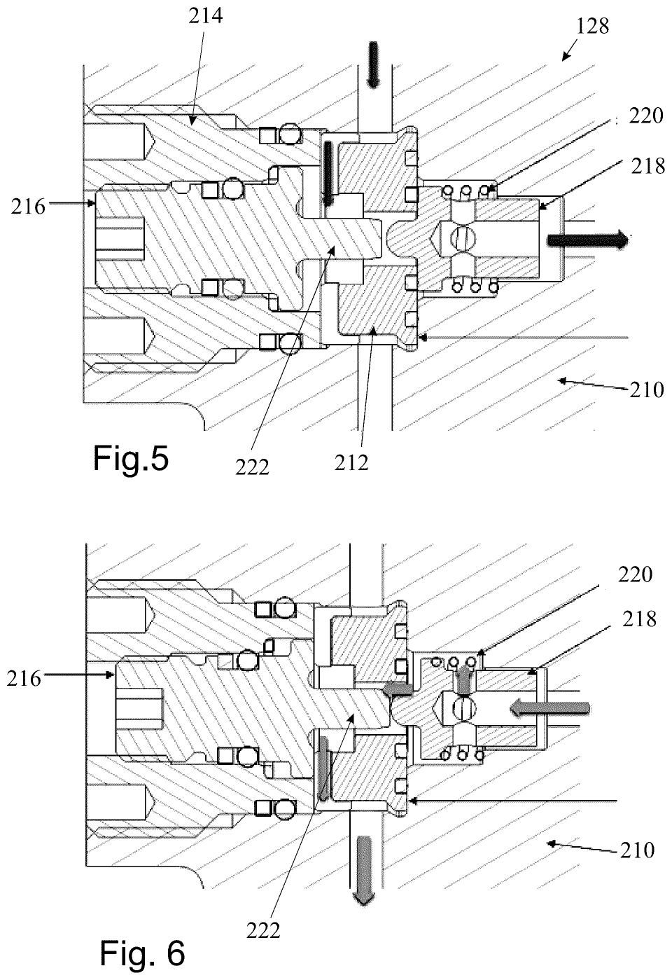

An embodiment of the combination valve 128 is shown in a first state in FIG. 5 and in its second state in FIG. 6. To receive the combination valve 128, a stepped through bore is drilled into the OTV body 210 and threaded at its wider outer end. The combination valve comprises a valve seat element 212 that is pressed against a shoulder of the stepped through bore by an annular collar 214. An actuator 216 is in screw-threaded engagement with the inner bore of the annular collar 214. A valve closure member or shuttle 218 is urged against the opposite side of the valve seat element 212 from the collar 220.

In its normal state, shown in FIG. 5, the actuator 216 is in a retracted position and makes no contact with the shuttle 218. An annular passage surrounding the valve seat 212 is connected to the consumer and the narrow end of the through bore leads into the interior of the tank. The check valve formed by the shuttle 218 and the valve seat element 212 now acts to allow unidirectional flow into the tank but not out of it. If the pressure in the annular passage exceeds the pressure in the line leading to the tank, the shuttle 218 is lifted off the valve seat element 212 against the action of the spring 220 and allows gas to flow in the direction indicated by the dark arrows in FIG. 5.

In its second state, shown in FIG. 6, the valve 128 has been actuated to allow free flow in both directions between the interior of the tank and the line leading to the consumer. In FIG. 6, the actuator 216 has been turned manually to a position in which a projection 222 at the end of the actuator 216 abuts the shuttle 218 of the check valve and separates it from the seat element 212 against the action of the spring 220, thereby maintaining the connection between the consumer line and the interior of the tank open at all times.

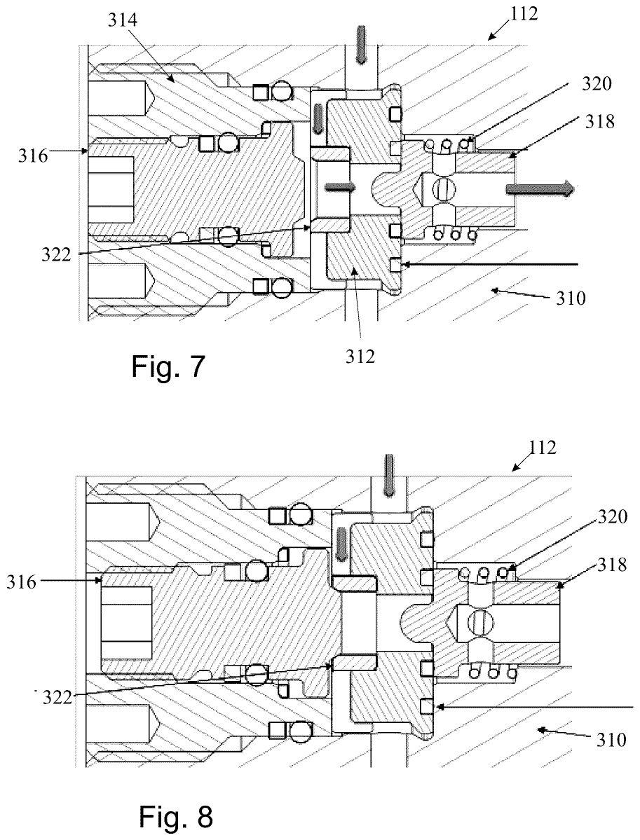

An embodiment of the combination valve 112 is shown in its first state in FIG. 7 and in its second state in FIG. 8. As with the combination valve 128, to receive the combination valve 112, a stepped through bore is drilled into the OTV body 310 and threaded at its wider outer end. The combination valve 112 comprises a valve seat element 312 that is pressed against a shoulder of the stepped through bore by an annular collar 314. An actuator 316 is in screw threaded engagement with the inner bore of the annular collar 314. A valve closure member or shuttle 318 is urged against the opposite side of the valve seat element 312 from the collar 314 by a spring 320.

The actuator 316 and the valve seat element 312 of the combination valve 112 differ from the corresponding components of the valve 128 in that the actuator does not have a projection capable of contacting the shuttle 318 and the valve seat element 312 is fitted with an annular insert 322 capable of sealing against the end of the actuator 316.

In its normal state, shown in FIG. 7, the actuator 316 is in a retracted position and makes no contact with the annular insert 322. As in the case of the combination valve 128, the annular passage surrounding the valve seat 312 is connected to the consumer and the narrow end of the through bore leads into the interior of the tank. The check valve formed by the shuttle 318 and the valve seat element 312 now acts to allow unidirectional flow into the tank but not out of it. If the pressure in the annual passage exceeds the pressure in the line leading to the tank, the shuttle 318 lifted off the valve seat element 312 against the action of the spring 320 and allows gas to flow in the direction indicated by the dark arrows in FIG. 6.

In its second state, shown in FIG. 8, the valve 112 has been actuated to isolate the tank. In FIG. 8, the actuator 316 has been turned manually and to a position in which its end seals against the insert 322 thereby preventing any gas from flowing through the valve seat element thereby maintaining the tank sealed at all times.

What is claimed is:

1. An on-tank valve for fitting to a tank and configured to permit a gas stored in the tank to be supplied to a consumer of the gas and to permit the tank to be replenished with the gas from a filling station, the on-tank valve having;
a valve body defining at least two flow passages in communication with the tank, a first of the two flow passages incorporating a solenoid valve configured to control the flow of gas from the tank to the consumer and the second incorporating a manually operable bleed valve configured to enable stored gas be supplied to the consumer while bypassing the solenoid valve,
the bleed valve being a combination valve movable manually between two states, in a first of the two states stored gas is permitted to flow from the tank to the consumer and in a second of the two states the second passage incorporates a non-return valve configured to permit the tank to be replenished from the filling station without the replenishment gas passing through the solenoid valve.

2. The on-tank valve as claimed in claim 1, wherein the first passage comprises a manually operable isolation valve connected in series with the solenoid valve.

3. The on-tank valve as claimed in claim 2, wherein the isolation valve is arranged between the solenoid valve and the tank.

4. The on-tank valve as claimed in claim 3, wherein the isolation valve is a combination valve movable manually between two states, wherein in the first of the two states the tank is isolated and in the second of the two states the tank is connected to the solenoid valve by way of a non-return valve oriented to be permit stored gas to flow from the tank to the solenoid valve.

5. The on-tank valve as claimed in claim 1, wherein the first passage also incorporates an excess flow valve disposed between the solenoid valve and the tank.

6. The on-tank valve as claimed in claim 1, wherein the first passage also incorporates a filter.

7. The on-tank valve as claimed in claim 1, wherein the valve body defines an additional passage connected to a temperature sensor.

8. The on-tank valve as claimed in claim 1, wherein the first passage additionally incorporates a pressure sensor.

9. The on-tank valve as claimed in claim 1, further comprising a thermally activated pressure relief device connected to the second passage between the tank and the bleed valve.
